(19) United States
(12) Patent Application Publication
(10) Pub. No.: US 2005/0252665 A1
(43) Pub. Date: Nov. 17, 2005

(54) Closure, which reacts to heat, for sprinklers and nozzles

(76) Inventor: Peter Kammer, Derendingen (CH)

Correspondence Address: TAROLLI, SUNDHEIM, COVELL & TUMMINO L.L.P., 526 SUPERIOR AVENUE, SUITE 1111, CLEVEVLAND, OH, 44114, US

(21) Appl. No.: 10/518,944

(22) PCT Filed: Jun. 3, 2003
(86) PCT No.: PCT/CH03/00349

§ 371 Date: May 24, 2005

(30) Foreign Application Priority Data
Jun. 12, 2002 (CH) 1004/02

(51) Int. Cl. A62C 37/08

(52) U.S. Cl. 169/42; 169/37

(57) ABSTRACT

A closure which reacts to heat is proposed for pressurized water and extinguishant. The outlet opening (10) is located at the end of an outlet channel (11) and is closed by a cover plate (20). This cover plate (20) is firmly connected to the nozzle body (2) by means of a melting initiator (5) composed of solder or adhesive which reacts to heat in a narrow melting range and, when initiated, it is washed away on reaching the desired rated temperature, without adversely affecting the spray pattern.

The present invention relates to a closure which reacts to heat for sprinklers and nozzles, according to the precharacterizing clause of patent claim 1.

Sprinklers, for example in stationary extinguishing facilities, are generally equipped with thermal elements which block the sprinkler opening by means of complex holding apparatuses and sealing elements in the readiness mode. The holding apparatuses are used as a secondary structure to secure the thermal elements in the readiness mode and operate directly or indirectly as water distributors (deflectors). The thermal elements are melting solder structures or small glass vessels, which are washed away by the emerging water when initiated. These holding and secondary structures adversely affect the uniform water distribution by causing so-called “spray shadowing” in the desired distribution of the water. Melting solder structures and small glass vessels are therefore not suitable for fine distribution of the extinguishant by means of sprinklers or nozzles. Sprinklers with thermal elements for emitting extinguishing liquid in stationary fire extinguishing systems have been known for a long time.

DE 27 03 459 discloses a sprinkler nozzle for vertical, hanging and horizontal installation with a nozzle body and a baffle plate, which is connected to the nozzle body by means of at least two supporting elements which act on the edge of the baffle plate, as well as an arrangement which blocks the nozzle opening of the sprinkler nozzle in the readiness mode and which comprises a closure element (which is seated in a sealing manner on the nozzle opening) and an initiating element which exerts a closing force on the closure element, which initiation results in the closing force on the closure element being cancelled out, such that it opens the nozzle opening immediately and completely for the extinguishing water jet to emerge. The closing element is provided with an ejection apparatus which, once the closing force has been removed, moves away together with the forward propulsion force of the extinguishing water jet, with the ejection apparatus being detachably supported on parts of the sprinkler nozzle that are firmly connected to one another, when said sprinkler nozzle is in the readiness position.

DE 29 24 654 describes a sprinkler for automatic fire extinguishing systems, comprising a housing which surrounds the flow channel for the fire extinguishant, a frame which is formed from two arms integrally formed on the housing and which is fitted with a distribution cap, a covering cap which closes the flow channel, and an assembly which is arranged between the two caps and has a lever, a supporting strut with two lugs that are perforated at the side and a temperature monitor which is inserted between the lugs. A projecting clamping bracket is provided on the supporting strut, whose longitudinally curved main section runs approximately parallel to the strut and strikes against the frame and the distribution cap when the sprinkler is initiated.

Both these and other known solutions (for example EP-A 0 505 672, U.S. Pat. No. 3,834,463 or U.S. Pat. No. 5,505,383) are generally suitable for emitting a more or less uniform spray jet, in the form of large droplets, of extinguishant. However, it is not possible to produce a regular spray mist, in the form of fine droplets, with many known sprinklers.

The desired fine distribution of the extinguishant, for example water, can be achieved by means of nozzles. The disadvantage of nozzles is that the process of fitting the thermal elements explained above results in the disadvantage of the formation of a spray shadow at the same time. Because the aim of nozzles is normally to achieve a finer, mist-like distribution of the extinguishant, this disadvantage has had such a major effect that nozzles have so far been used predominantly in open systems. This means that the extinguishing system is not initiated by a thermal element on the nozzle itself, but is carried out by auxiliary devices and/or systems.

The present invention is now based on the object of improving a closure, which reacts to heat, for sprinklers and nozzles for stationary fire extinguishing systems of the type mentioned initially, such that they hold back the pressurized extinguishant, and open immediately, completely and without adversely affecting the spray pattern on reaching a critical, previously determined rated temperature in the area, and thus initiate the extinguishing function reliably, without any impediment and on an urgent basis.

This object is achieved by a closure, which reacts to heat, for sprinklers and nozzles for stationary fire extinguishing systems having the features of patent claim 1. Further features according to the invention are described in the dependent claims, and their advantages are explained in the following description.

In the drawing:

FIG. 1 shows a section through a closure,

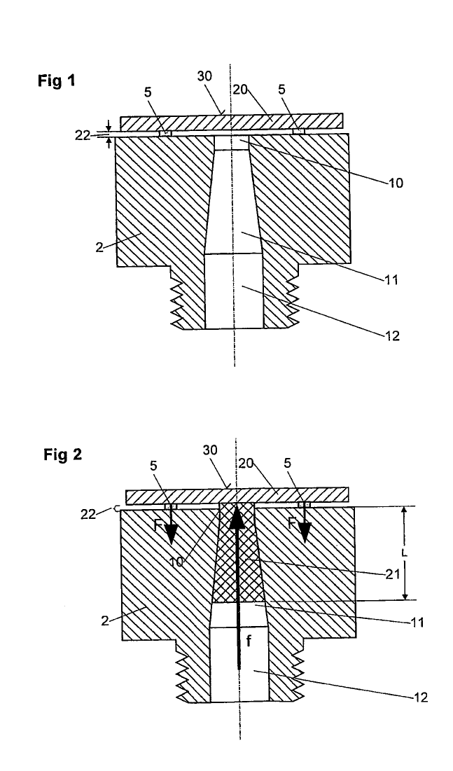

FIG. 2 shows a section through a closure with pins,

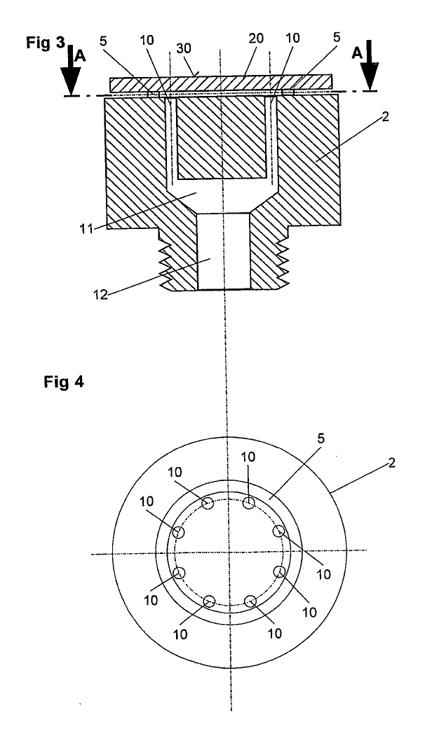

FIG. 3 shows a section through a closure with a multiple nozzle

FIG. 4 shows a plan view of A-A of a closure with a multiple nozzle

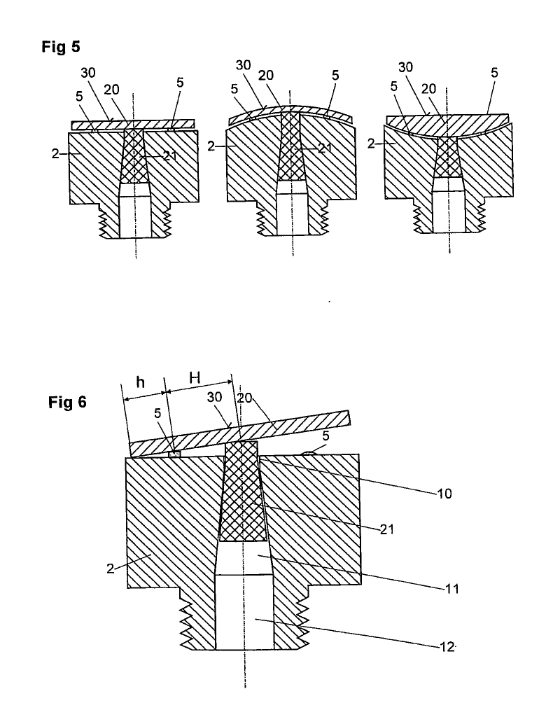

FIG. 5 shows various forms of closures

FIG. 6 shows a section through an opening closure

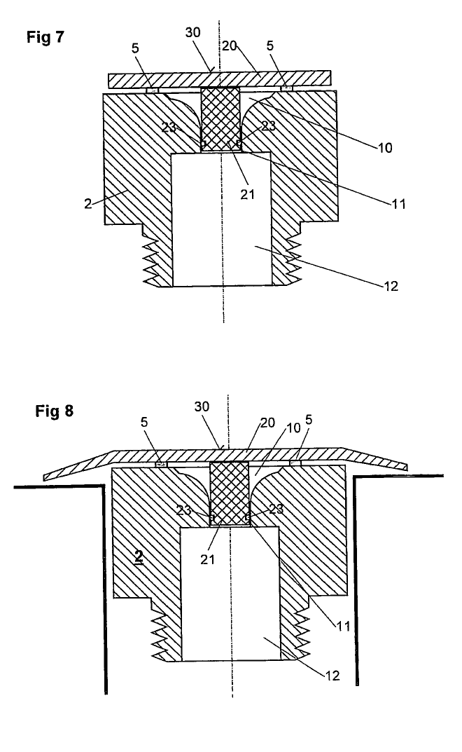

FIG. 7 shows a section through a closure with a sealing element

FIG. 8 shows a closure with an enlarged cover plate 20

FIG. 9 shows a closure with a multiple nozzle, and

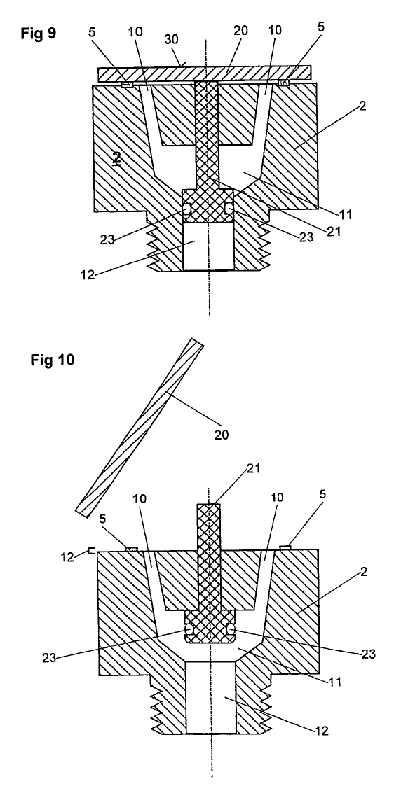

FIG. 10 shows a closure with a multiple nozzle.

The figures illustrate preferred exemplary embodiments, which will be explained in the following description.

The apparatuses on which the invention is based are suitable for use with all possible extinguishants, such as water, chemicals and gases.

A closure which reacts to heat for sprinklers and nozzles is illustrated in the form of a section in FIG. 1. The figure shows the nozzle body 2 with a supply for extinguishant through the inlet channel 12, the outlet channel 11 and the outlet opening 10. The outlet channel is matched to the extinguishant and is designed such that the desired distribution of the extinguishant is achieved. All forms and combinations of inlet channels 12, outlet channels 11 and outlet openings 10 which are normally used for atomization of liquids and liquid/gas mixtures, as well as for the distribution of gases, may be used. The nozzle body 2 is firmly soldered or adhesively bonded by means of a melting initiator 5 to a cover plate 20 when in the readiness mode.

The shape of the nozzle body 2 and of the cover plate 20, that is to say the shape of the surface 30 which can be seen by the viewer in the installed state, may be as required (FIG. 5). In particular, the flat termination of the nozzle body 2 (as illustrated in FIG. 1 to FIG. 4) in the region of the outlet opening 10 is illustrated only for the sake of simplicity. The shape of the terminating surface of the nozzle body 2 normally matches the shape of that surface of the cover plate 20 which faces it and is connected to it by means of the melting initiator 5, so that the two parts can be firmly connected in a sealed manner by the melting adhesive 5 (FIG. 5).

The surface of the cover plate 20 may be designed appropriately in order to ensure that atomization nozzles in the surface of ceilings “disappear” visually when installed. Both the shape of the plane and its surface characteristic and its size (FIGS. 5 and 8) may be used as a design element and may be matched to the ceiling structure.

Nozzles which are continuously subject to pressure and are in contact with the extinguishing medium tend to become baked. If the extinguishant is water, severe lime deposits are often found. Such lime deposits in the channels are undesirable and adversely affect the guarantee that the nozzles will operate, and they also result in a considerable deterioration in the operation of the nozzle. After a particularly long time, the deposit may even make itself evident in the form of a plug of lime, such that no extinguishant whatsoever can any longer pass through the nozzle. In order to counter this risk, the outlet channel 11 and the outlet opening 10 in the closure which reacts to heat according to the invention are provided with a pin 21 (FIG. 2).

A pin 21 such as this may be produced from a sealing compound, plastic/elastic material with suitable sliding characteristics (FIGS. 2, 5 and 6) or from a solid material, for example steel (FIGS. 7 to 10). If a solid material is used, a sealing element 23 (FIGS. 7 to 10) must be provided. The pin 21 is supported on the cover plate 20, which is firmly connected to the nozzle body 2 in the readiness mode, and follows the contours of the outlet channel 11 and of the outlet opening 10 over a length L (FIG. 2).

As soon as the cover plate 20 is forced away by the intended initiation, the pressure of the extinguishing medium causes the plug to leave the outlet channel 11 through the outlet opening 10, without leaving any residue in the outlet channel 11 or in the outlet opening 10.

The cover plate 20 is connected to the nozzle body 2 by means of a defined melting initiator 5, which is arranged in any desired manner, by way of example in the form of an annulus in the figures, and which seals the nozzle. Solders or adhesives with a narrow melting range may be used as the melting initiator 5 of the type proposed according to the invention. Irrespective of whether solder or adhesive is used, this material must be solid at room temperature and must have a good tensile strength as well as good adhesive characteristics to the materials of the nozzle body 2 and of the cover plate 20. A material which has a clearly defined melting range, which is as narrow as possible, is also used as the material for the melting initiator 5. This melting range ideally has a tolerance of ±0 to 3° C. about the rated temperature range. Material with a melting range at rated temperatures from 50° C. to 350° C. may be used, depending on the application.

The gap 22 between the nozzle body 2 and the cover plate 20 should be minimal. It is chosen to be as large as necessary, and as small as possible. The strength of the connection between the nozzle body 2 and the cover plate 20 and the characteristics of the melting initiator 5 determine the size of the gap 22. It is desirable for the gap to have a maximum size of 0.001 to 1 mm.

The force F which would be necessary in order to release the cover plate 20 from the nozzle body 2 at room temperature must be at least one and a half times greater than the force f which acts on the cover plate 20 as a result of the pressure of the extinguishant via the outlet opening 10 or via the pin 21.

As described above, the melting initiator 5 melts when the intended temperature occurs, irrespective of the original temperature of the environment to be monitored. As soon as an intended environmental temperature reaches the previously defined values, it can be assumed that a fire has occurred, and the closure which reacts to heat will open. If the apparatus is used for process monitoring, for example in a reactor whose area could no longer be monitored above a certain temperature, the initiating temperature may be up to 300° C. or more. In this case, an extinguishing liquid which is suitable for the particular application, or a gas which stops the reaction is used.

For correct operation of the atomization nozzle 1, it is important for the nozzle to open immediately and entirely. For this purpose, the cover plate 20 must be removed immediately and entirely when initiation occurs. The invention now provides for the melting initiator 5 to melt on reaching the critical temperature, so that the cover plate 20 is no longer connected to the nozzle body 2. It would be feasible for the melting process of the mass of the melting initiator 5 not to take place uniformly everywhere. In order to satisfy the requirement for immediate and total opening of the outlet opening 10, the melting initiator connection between the nozzle body 2 and the cover plate 20 is arranged at some distance from the edge of the nozzle body 2 (FIGS. 1 to 5). It can be assumed that an area of the melting initiator 5 will melt, and will release the cover plate 20 on one side (FIG. 6). The cover plate 20 is subjected to continuous pressure from the extinguishant, directly or via the pin 21. When the melting initiator 5 no longer withstands this pressure, the cover plate 20 is suddenly released. This rapid process results in the cover plate 20 being released on one side with a certain speed and inertia force, FIG. 6. The lever effect (H>h) now results in the effect that the melting initiator 5 is torn away even if parts of it have not melted completely, so that the cover plate 20 is separated from the nozzle body 2 and the closure which reacts to heat opens immediately, completely and without any adverse effect on the spray pattern. The nozzle now starts to release the extinguishant. Depending on the system type, the resultant pressure may be increased by appropriate means after a nozzle has opened, in order to achieve even better water distribution.

The spray mist is prepared in a nozzle by the shape of the outlet channel 11, of the outlet opening 10 and of the upstream inlet channel 12, for example by means of built-in swirling bodies. In order to ensure that the extinguishant is emitted during operation, the outlet channel 11 and the outlet opening 10 must therefore be protected against becoming dirty. It is possible for the solution as described above, by means of pins 21, not to satisfy this requirement.

An apparatus is therefore proposed in FIG. 7 which is sealed by means of a sealing element 23 in a cylindrical part of the outlet channel 11. In this case, a hard material such as steel or reinforced plastic is chosen for the pin 21. A seal of any desired shape is used as the sealing element 23, for example a lip seal, an O-ring or else a conventional packaging material. The pressurized extinguishant penetrates only into the inlet channel 12, and is then held back by the sealing element 23 and the pin 21. The seal 23 thus prevents the extinguishant from reaching the outlet channel 11 and the outlet opening 10, thus ensuring that there are no deposits there which could interfere with the spraying process.

When a situation now occurs in which the closure which reacts to heat is opened by the cover plate 20 being released, the pin 21 is pushed out by the extinguishant, and the extinguishant can flow via the outlet channel and outlet opening. While the flow is taking place, it is then changed in the inlet channel 12, the outlet channel 11 and the outlet opening 11 so as to form a spray pattern or a spray mist of the desired type.

The proposed closure which reacts to heat for sprinklers and nozzles offers further advantages for the operation and design of the closure. The external dimensions and shape of the cover plate 20 may be larger than those illustrated in FIG. 8, and may be different to the external shape or the diameter of the nozzle body 2. This thus results in a larger area to which the environmental temperature is applied for operation, thus making the initiation of the closure which reacts to heat more reliable and safer. In addition to this advantage, this arrangement offers the capability to accommodate and close a closure such as this cleanly in a ceiling by means of a cover in order, as already described, to make it possible to match the closure to the design of the ceiling.

1. Closure which reacts to heat for pressurized water and extinguishant, characterized in that the outlet opening (10) which is located at the end of the outlet channel (11) is closed by a cover plate (20) which is firmly connected to the nozzle body (2) by means of a melting initiator (5).

2. Closure according to claim 1, characterized in that the melting initiator (5) is a solder with a defined rated temperature and a narrow melting range, and the connection between the cover plate (20) and the nozzle body (2) is a soldered joint.

3. Closure according to claim 1, characterized in that the melting initiator (5) is an adhesive with a defined rated temperature and a narrow melting range, and the connection between the cover plate (20) and the nozzle body (2) is an adhesively bonded joint.

4. Closure according to claim 1, characterized in that a pin (21) which touches the cover plate (20) is arranged in the outlet channel (11) and outlet opening (10).

5. Closure according to claim 1, characterized in that the pin (21) is matched to the contours of the outlet channel (11) in an interlocking form over a certain distance L.

6. Closure according to claim 1, characterized in that the material used for the melting initiator (5) has a melting range with a maximum tolerance of 6° C.

7. Closure according to claim 1, characterized in that the melting range of the melting initiator (5) is a rated temperature range between 50° C. and 300° C.

8. Closure according to claim 1, characterized in that the holding force F of the connection by means of the melting initiator (5) is at least one and a half times greater than the force f acting on the cover plate (20) as a result of the pressure of the extinguishant.

9. Closure according to claim 5, characterized in that the pin (21) has a sealing element (23) in the region of the outlet channel (11).

10. Closure according to claim 5, characterized in that the pin (21) has a sealing element (23) in the region of the inlet channel (12).

11. Closure according to claim 9, characterized in that the pin (21) and the cover plate (20) are produced integrally.
